(19) United States
(12) Patent Application Publication
(10) Pub. No.: US 2015/0208197 A1
(43) Pub. Date: Jul. 23, 2015

(54) USER-PLANE (SUPL) BASED POSITIONING METHOD FOR MINIMIZATION OF DRIVE TEST (MDT) IN MOBILE NETWORKS

(71) Applicant: Nokia Corporation, Espoo (FI)

(72) Inventors: Ilkka Antero Keskitalo, Oulu (FI); Jarkko Tuomo Koskela, Oulu (FI); Jussi-Pekka Koskinen, Oulu (FI)

(21) Appl. No.: 14/414,754

(22) PCT Filed: Aug. 7, 2012
(86) PCT No.: PCT/US2012/049873

§ 371 Date: Feb. 27, 2015

(51) Int. Cl. H04W 4/02; H04W 4/20; H04W 24/04

(52) U.S. Cl. CPC H04W 4/02; H04W 24/04; H04W 4/20

(57) ABSTRACT

In one aspect there is provided a method. The method may include activating, at the user equipment, positioning based on a start command received from a user plane agent via a user plane connection, wherein the start command activates positioning at the user equipment in order to provide positioning information for a minimization of drive testing processing; and sending, by the user equipment, at least one of a minimization of drive testing report and the positioning information. Related apparatus, systems, methods, and articles are also described.

### FIELD

The subject matter described herein relates to wireless communications.

### BACKGROUND

Operators test their networks to identify coverage holes (also referred to as dead zones) or weak coverage areas in their networks. The drive test is a manual process that literally includes driving in a vehicle to collect power, location, and other measurements to build coverage maps and identify potential coverage holes or other issues in the radio network. Once an operator identifies a coverage hole, the operator may attempt to enhance existing coverage to address the hole by, for example, adding a base station, increasing power, changing the orientation of base station antennas, and the like. Operators may also want to verify the service quality that is provided in different parts of the network and thus measure available data rates/throughputs at various locations and under various radio circumstances.

Operators have typically performed manual testing and verification of cellular radio networks by performing drive testing which includes specific measurements to collect data and to verify the operation of the network. Minimization of drive testing (MDT) may, however, provide a framework, which includes numerous standards seeking to overcome the costs and environmental impact related to traditional, manual drive testing. Instead of manual drive testing, the network and/or the user equipment collect measurements to allow MDT and thus perform testing of the network, such as network coverage, capacity optimization, optimization of mobility parameters, quality of service verification, location (e.g., global navigation satellite system information, cell identifier(s), radio frequency signal measurements-based location, and the like), and the like. Indeed, numerous standards have been specified to provide a framework for MDT. Examples of standards which can be used in testing user equipment include: (1) 3GPP TS 34.109, V10.1.0 (2011-12), Technical Specification: 3rd Generation Partnership Project; Technical Specification: Group Radio Access Network; Terminal logical test interface; Special conformance testing functions (Release 10); (2) 3GPP TS 37.320, V10.4.0 (2011-12), Technical Specification: 3rd Generation Partnership Project; Technical Specification: Group Radio Access Network; Universal Terrestrial Radio Access (UTRA) and Evolved Universal Terrestrial Radio Access (E-UTRA); Radio measurement collection for Minimization of Drive Tests (MDT); Overall description; Stage 2 (Release 10); (3) 3GPP TS 36.331, V10.4.0 (2011-12), Technical Specification: 3rd Generation Partnership Project; Technical Specification Group Radio Access Network; Evolved Universal Terrestrial Radio Access (E-UTRA); Radio Resource Control (RRC); Protocol specification (Release 10), (4) 3GPP TS 36.355, V10.4.0 (2011-12), Technical Specification: 3rd Generation Partnership Project; Technical Specification Group Radio Access Network; Evolved Universal Terrestrial Radio Access (E-UTRA); LTE Positioning Protocol (LPP) (Release 10); (5) 3GPP TS 36.509, V9.5.0 (2011-09), Technical Specification: 3rd Generation Partnership Project; Technical Specification Group Radio Access Network; Evolved Universal Terrestrial Radio Access (E-UTRA) and Evolved Packet Core (EPC); Special conformance testing functions for User Equipment (UE) (Release 9); (6) 3GPP TS 36.508, V9.7.0 (2011-12), Technical Specification: 3rd Generation Partnership Project; Technical Specification Group Radio Access Network; Evolved Universal Terrestrial Radio Access (E-UTRA) and Evolved Packet Core (EPC); Common test environments for User Equipment (UE) conformance testing (Release 9); (7) 3GPP TS 32.422 Technical Specification Group Services and System Aspects, Telecommunication management, Subscriber and equipment trace, Trace control and configuration management; and any additions and revisions to these and other standards.

MDT measurement and subsequent reporting may include two modes referred to herein as immediate MDT and logged MDT. MDT reports from the user equipment to the network may be immediate, when the user equipment is in an active, or a connected mode. This immediate reporting corresponds to the normal reporting expectations for radio resource management (RRM). Moreover, the MDT reports sent by the user equipment to the network may be triggered by an event, a timer (e.g., a periodic time), a signal level or quality, a failure event such as radio link failure or handover failure, and the like, and/or by a request. In the case of MDT reporting when the user equipment is in an idle mode, in which case immediate MDT reporting is not possible, the user equipment may record (also referred to as log) MDT measurements made by the user equipment and wait until a connection is available between the user equipment and the network in order to send the MDT report. In any case, the network may receive one or more MDT reports to assess the performance of the network, such as network coverage, capacity optimization, optimization of mobility parameters, quality of service verification, and the like.

### SUMMARY

In some example embodiments, there may be provided a method. The method may include receiving, at a user plane agent, an indication to activate positioning at a user equipment to provide positioning information for a minimization of drive testing processing; establishing, based on the received indication, a user plane connection, between a location server and the user equipment; and sending, by the user plane agent, a start command via the user plane connection to activate the positioning at the user equipment.

In some variations of some of the embodiments disclosed herein, one or more of the following may be included. The user plane connection may comprise a secure tunnel configured in accordance with secure user plane location. The user equipment may comprise a secure user plane location enabled terminal. The location server may comprise a secure user plane location platform. The receiving may further comprise receiving, during a trace function used for the minimization of drive testing processing, the indication at a network node comprising, or connected to, the user plane agent. The network node may comprise at least one of a mobility management entity, a radio access node, or an operations and maintenance node. The at least one of a positioning method for use at the user equipment and an assistance information may be sent via the user plane connection to the user equipment to assist in a global navigation satellite system positioning at the user equipment.

In another aspect, there may be a method including activating, at the user equipment, positioning based on a start command received from a user plane agent via a user plane connection, wherein the start command activates positioning at the user equipment in order to provide positioning information for a minimization of drive testing processing; and sending, by the user equipment, at least one of a minimization of drive testing report and the positioning information

In some variations of some of the embodiments disclosed herein, one or more of the following may be included. The user plane connection may comprise a secure tunnel configured in accordance with secure user plane location. The user equipment may comprise a secure user plane location enabled terminal. The receiving may further comprise receiving, during a trace function used for the minimization of drive testing processing, the start command at a network node comprising the user plane agent. The start command may be received from the network node comprising at least one of a mobility management entity, a radio access node, or an operations and maintenance node. The activating may further comprise activating a global navigation satellite system positioning at the user equipment.

The above-noted aspects and features may be implemented in systems, apparatus, methods, and/or articles depending on the desired configuration. The details of one or more variations of the subject matter described herein are set forth in the accompanying drawings and the description below. Features and advantages of the subject matter described herein will be apparent from the description and drawings, and from the claims.

### DESCRIPTION OF DRAWINGS

In the drawings,

FIG. 1 depicts a block diagram of a wireless communication system configured to provide control plane and user plane positioning information for use in minimization of drive testing, in accordance with some example embodiments;

FIG. 2 depicts a block diagram of a wireless communication system configured to provide user plane positioning information for use in signaling-based minimization of drive testing, in accordance with some example embodiments;

FIG. 3 depicts an example process for initiating a Trace function in order to collect measurement results and positioning information for use in minimization of drive testing, in accordance with some example embodiments;

FIG. 4 depicts a block diagram of a wireless communication system configured to provide user plane positioning information for use in area management-based minimization of drive testing, in accordance with some example embodiments;

FIG. 5 depict a process for providing user plane positioning information to a MDT function in the network, in accordance with some example embodiments;

FIG. 6 depicts another example of a wireless communication system, in accordance with some example embodiments;

FIG. 7 depicts an example of a base station, in accordance with some example embodiments; and

FIG. 8 depicts an example of user equipment, in accordance with some example embodiments.

Like labels are used to refer to same or similar items in the drawings.

### DETAILED DESCRIPTION

In some exemplary embodiments, MDT reporting is supplemented with additional position information representative of where the measurements were made, and this position information may be provided by a user plane activation of the positioning function at the user equipment using, for example, Secure User Plane Location (SUPL) to a location server. SUPL refers to a secure connection, such as a secure tunnel and the like, between a user equipment and a location server, such as a SUPL Location Platform (SLP). The user equipment may be enabled to operate with SUPL, in which case the user equipment may also be referred to as a SUPL enabled terminal (SET). This SUPL connection may by-pass the mobile network by establishing a direct IP connection via the user plane between the SUPL function at the user equipment and the SLP. The SUPL interface between the SLP and user equipment may be specified by a standard protocol, such as User Plane Location Protocol, OMA-TS-ULP-V3_{—}0-20110920-C, although other types (including proprietary interfaces) may be used as well. Moreover, the SUPL may be performed in addition to, or instead of, control plane signaling with the location servers.

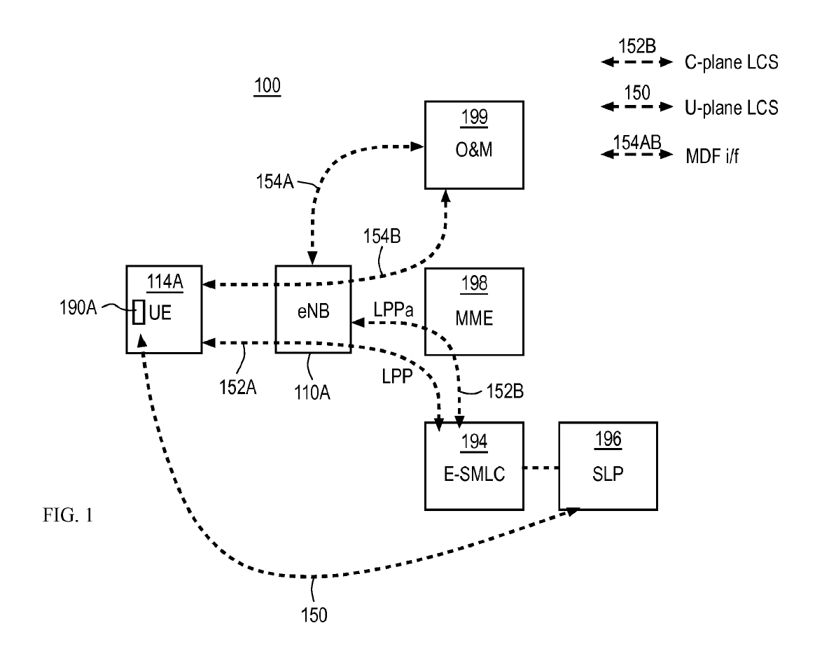

FIG. 1 depicts an example system 100, in accordance with some example embodiments. System 100 may include a user equipment 114A having a SUPL function 190A to allow a secure user plane session via connection 150 to a location server, such as a SUPL Location Platform (SLP) 196. The SUPL session may allow the SLP 196 to initiate the SUPL session, provide parameters, such as positioning method to be used, capabilities of the SLP, provide assistance information to assist in global navigation satellite system (GNSS) positioning at the user equipment, and activate positioning at the user equipment to allow the user equipment 114A to provide positioning (e.g., location) information for MDT reporting.

System 100 may also include control plane signaling connections 152A-B. Specifically, user equipment 114A provides positioning information for MDT reporting via connections 152A using a LTE location Protocol (LPP) with a location server, such as an Evolved Serving Mobile Location Centre (E-SMLC) 194, which may be further coupled to SLP 196, while the E-SMLC 194 and base station 110A communicate location information for MDT reporting via connection 152B using the LTE location Protocol A (LPPa).

The O&M node 199 may also have interfaces to configure MDT measurements and to obtain MDT reports via connection 154B or 154A (in the case of area management based MDT reporting described further below). The O&M node 199 may include an MDT function.

In some exemplary embodiments, the network, such as a network management (NM) node, a network operation and maintenance (O&M) node, and the like, may request that the MDT report include the positioning information activated by the SUPL session with an SLP 196. For example, the user equipment 114A provides MDT reports to the network and these reports may include positioning, such as GNSS location information, triggered by SLP 196 via a user plane connection, such as a SUPL via connection 150. Moreover, SLP 196 may provide assistance information to assist the user equipment to generate the GNSS location information. In the case of terrestrial positioning, the user equipment 114A may provide MDT reports to SLP 196, where downlink positioning (e.g., observed time difference of arrival location) may be used to determine the location of the user equipment. This terrestrial positioning information may be provided to O&M node 199 along with the MDT reports.

In some example embodiments, the network may request the user equipment to attempt activation of the positioning to get location information for MDT reports. This request may be initiated during a Trace process, such as the Trace process described in 3GPP TS 32.422 V11.3.0 (2012-03), 3rd Generation Partnership Project, Technical Specification Group Services and System Aspects, Telecommunication management, Subscriber and equipment trace, Trace control and configuration management (Release 11), although subsequent additions and revisions to this standard as well as other processes may be used as well. In the case of 3GPP TS 32.422, a Trace session request may initiate MDT measurements by selecting a certain user equipment (referred to as signaling-based MDT) and/or configuring the radio access network (e.g., base stations, radio network controllers, and the like) to start MDT measurements and reporting from the one or more user equipment selected by the radio access network (which is referred to as area management based MDT). In some example embodiments, the positioning request may also be initiated by other network nodes, such as a mobility management entity (MME), an eNB, a RNC, and the like.

The following description relates to signaling based MDT, although some aspect may be utilized with area management based MDT as well.

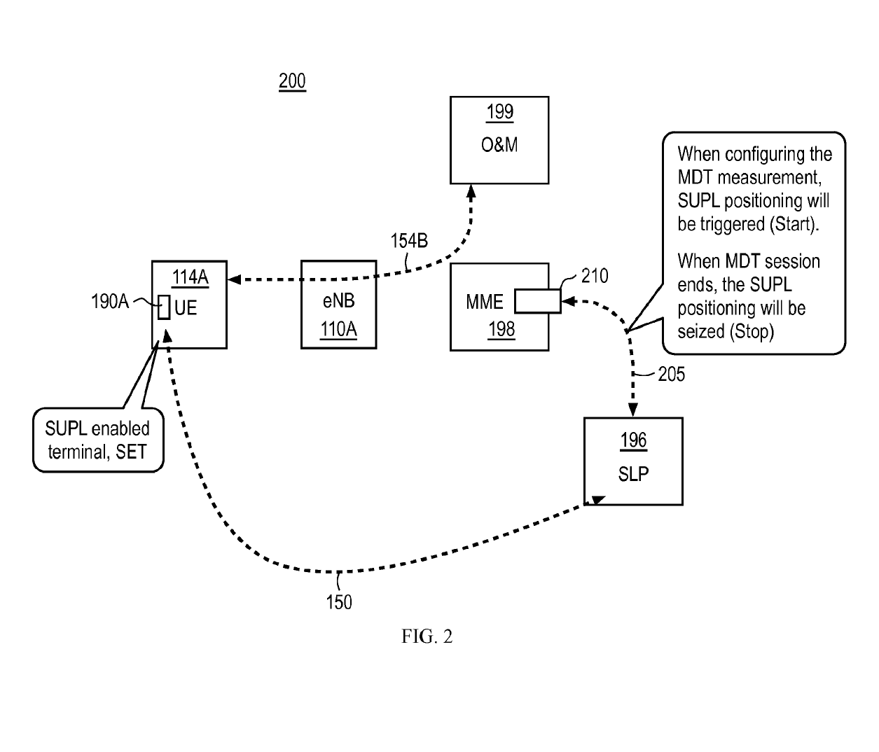

FIG. 2 depicts a system 200 depicting signaling based MDT, in accordance with some example embodiments. In some example embodiments configured to operate using signaling based MDT, a node, such as O&M node 199, may provide to MME 198 a request to initiate an MDT session. For example, O&M node 199 may initiate a Trace session by sending a request (including MDT configuration information) to the MME 198 to start the MDT session. When this is the case, MME 198 may forward the MDT configuration via the radio access network (e.g., base station 110A, and the like) to the user equipment 114A (e.g., via radio resource control (RRC) signaling with the user equipment), and the MDT configuration may be provided to the user equipment 114A, when the user equipment 114A goes into a connected state (although the configuration may be provided at other times as well).

In some example embodiments, one or more user equipment may be selected for MDT reporting based on its identity (e.g., an international mobile subscriber identity (IMSI), an international mobile equipment identity (IMEI), and the like). This user equipment identity may be checked by a node, such as MME 198, to determine whether the selected user equipment, such as user equipment 114A, consents to MDT reporting and/or providing positioning information to the network.

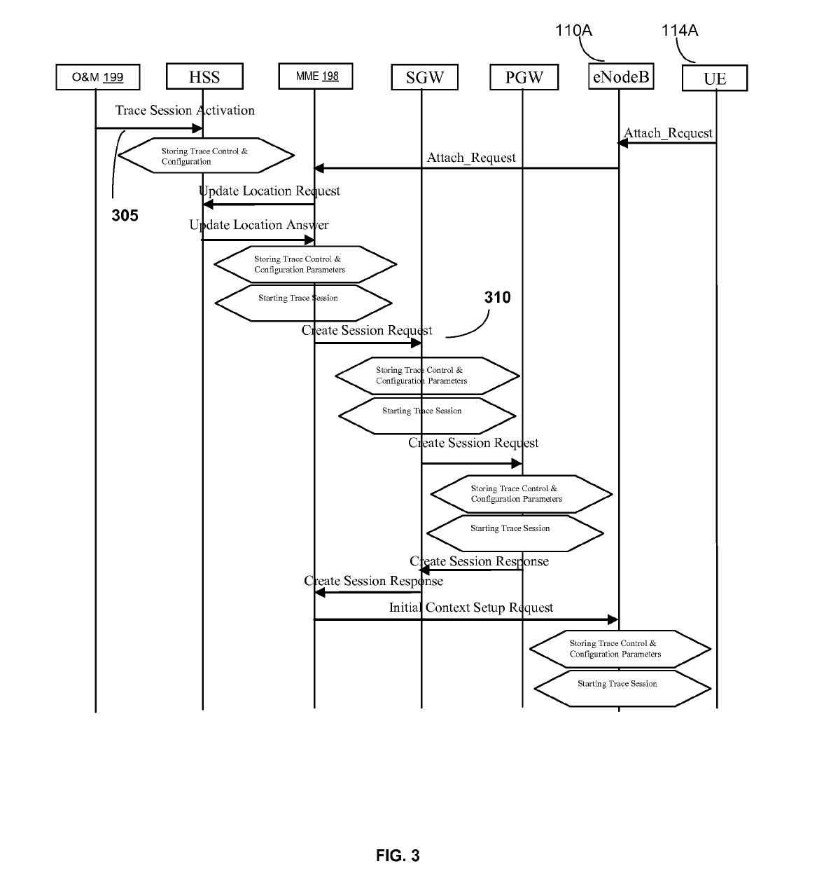

FIG. 3 depicts an example process 300 in accordance with some example embodiments. In the example process 300, the O&M node 199 initiates, at 305, a trace session 305 to activate collection of MDT measurements including positioning information obtained via at least one of a control plane or a user plane. The trace request is forwarded (via other nodes, such as a home subscriber server, HSS) to MME 198 after the user equipment has established a connection to the network. As the MME 198 is aware of the identity of the user equipment, MME 198 may check the user equipment's consent for MDT and/or providing position information. And, if there is consent, the MME 198 may send a request 310 to activate MDT session with requested positioning at the selected user equipment, such as user equipment 114A.

Referring again to FIG. 2, the MME 198 may include, or have a connection to, a SUPL agent 210. The MME 198 may access the SUPL agent 210 to trigger the establishment of a SUPL session between the SUPL agent 210 and the SLP 196 and a SUPL session via connection 150 between the SLP 196 and the SUPL function 190A at user equipment 114A. For example, SUPL agent 210 may, at 205, trigger the establishment of a SUPL session between SLP 196 and user equipment 114A by at least sending a start command. The SUPL agent 210 may, at 205, terminate the SUPL session between SLP 196 and user equipment 114A by at least stop command. For example, when the O&M node sends a Trace session end/stop for MDT measurements to MME 198 (or when the user equipment releases the connection which ends MDT reporting), the SUPL agent 210 may, triggered by MME, stop the positioning and thus terminate the SUPL session via 150 to user equipment 114A. The start and stop commands may be sent in accordance with standardized SUPL signaling to activate and/or deactivate the positioning function at the user equipment 114A.

Moreover, the SUPL session via connection 150 may thus be used to start of positioning, configure the provisioning, and/or provide positioning assistance information to assist in GNSS positioning at the user equipment 114A including SUPL function 190A, so that the GNSS positioning information may be used for MDT reports/measurements provided by the user equipment 114A to the network. For example, user equipment 114A may provide MDT reports to OAM node 199 and those MDT reports may include GNSS positioning information where GNSS positioning is activated via the SUPL session at connection 150.

In some example embodiments, the interface at 205 between SUPL agent 210 and SLP 196 may be a so-called thin interface configured to allow the MME 198 to, for example, start a SUPL session to a selected user equipment or stop the SUPL session to the selected user equipment. For example, the MME 198 may identify one or more user equipment, and request the start of SUPL session(s) for the MDT at the identified user equipment.

SUPL agent 210 may, as noted, use a standard signaling procedure with the SLP 196, which may in turn use standard signaling procedure with the user equipment 114A. An example of such as a user plane signaling procedure is found in OMA TS-ULP-V3 _{—}0-20110920-C, although other protocols may be used as well. In any case, when the SUPL agent 210 and/or SLP 196 are configure to initiate positioning at the user equipment, the configuration information may include one or more of the following: positioning method (e.g., global navigation satellite system, cell based, terrestrial positioning, and the like); a trigger type for provisioning of the location information (e.g., single shot, periodic, location event, velocity event, and the like); one or more identifiers for the user equipment, and the like. The configuration may also include a desired periodicity and other parameters related to filtering, for example. Periodicity and length of the positioning may also be aligned with corresponding MDT configuration parameters.

Although FIG. 2 depicts the SUPL agent 210 at the MME 198 having a connection to the MME 198, the SUPL agent 210 may, in some example embodiments, be located in, or connected to, other nodes as well, such as at a O&M node 199 (e.g., a Trace Collection Entity (TCE), at a radio access network (RAN) node (e.g., an evolved Node B type base station (eNB) in accordance with the Long Term Evolution (LTE) series of standards), or the like. For example, the SUPL agent 210 may be located in, or connected to, the O&M domain, such as at O&M node 199. When this is the case, the Trace session request may trigger the SUPL agent 210 to initiate a SUPL session between SLP 196 and the user equipment selected for MDT reporting as the O&M 199 is normally aware of the user equipment identity (e.g., IMSI, IMEI and the like) as well as user equipment consent for MDT and sharing location information.

In some example embodiments, the SUPL agent 210 may be located in the radio access network. For example, a radio network controller (RNC, e.g., in accordance with a Universal Terrestrial Radio Access Network (UTRAN)) may be made aware of the user equipment's identity and thus may inform the SUPL agent 210 about the user equipment's identity selected for MDT reporting/measurements (and to which the SUPL session will be established). To further illustrate, an evolved Node B type base station (eNB, e.g., in accordance with a Long Term Evolution (LTE)) is normally not aware of the user equipment's identity for security reasons, so an S1 signaling bearer may be extended to allow a determination of the user equipment identities required for the SUPL connection to the selected user equipment, or the SUPL agent 210 may establish a separate, secure connection to the core network or the O&M node 199 to obtain the user equipment's identity before establishing the SUPL connection to the selected user equipment. When configuring MDT reporting at the selected user equipment, the eNB base station may also trigger the SUPL agent 210 to initiate a SUPL session in order to start positioning function at the selected user equipment. The positioning function may, as noted, include global navigation satellite system positioning (which may be assisted by SLP 196), terrestrial positioning (e.g., downlink observed time difference of arrival), cell identifier techniques, and other like positioning techniques.

In some example embodiments, the user equipment 114A may, as noted, be configured via the SUPL session at 150 to provide GNSS location information. When this is the case, the SUPL session at 150 may also provide assistance information to the user equipment to speed up the user equipment's synchronization to satellite signals (which may also improve the positioning reaction time to MDT positioning requests by minimizing the time until the GNSS coordinates are available for MDT measurement results).

Moreover, the MDT reports may include time stamps (or references) in order to allow MDT function at the O&M node to correlate the MDT measurement reports (which also include time stamps) with other network information residing in the O&M domain. This network information may consist of system parameter values that may vary in time. For example, a radio access node may attach a time stamp to an MDT report when the requested positioning is applicable for an immediate MDT (e.g., when there is a radio connection).

In some example embodiments, the user equipment capabilities may be taken into account, when activating the SUPL positioning at the user equipment 114A. For example, SLP agent 210 and/or SLP 196 may select the positioning method as either GNSS or terrestrial positioning based on the capabilities of the user equipment, although other sources of location information may be used as well. This kind of capability information may be kept in the SUPL agent 210 or in SLP 196 based on information from earlier SUPL sessions with user equipment. Moreover, the selected positioning method may be made during the SUPL session itself using, for example, a SUPL NOTIFY signaling message.

The following description relates to management based (or area based) MDT, although some aspect may be utilized with signaling based MDT as well.

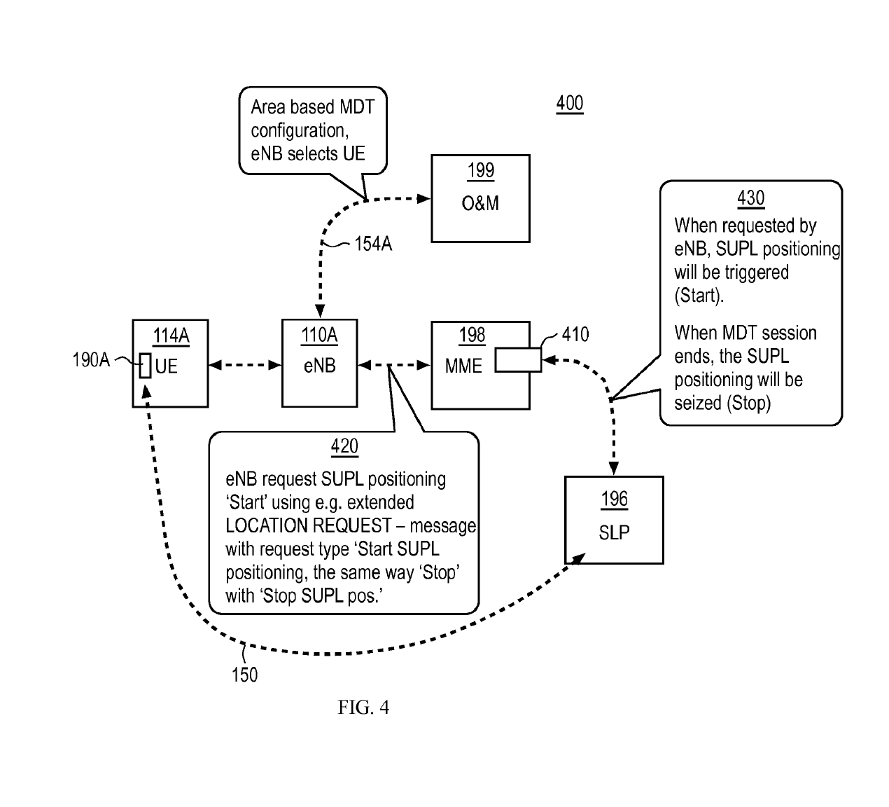

FIG. 4 depicts an example of a system 400 for on-demand SUPL positioning during area management based MDT, in accordance with some example embodiments. System 400 is similar to system 200 in some respects.

In management based MDT, the user equipment selected for MDT reporting is done by a node in the RAN, such as an eNB base station, an RNC, and the like. Because the RAN may not be aware of the identity of the user equipment (e.g., due to privacy and security reasons), the RAN node may be informed of the user equipment's consent to MDT and capability to provide positioning information to the network during, for example, an initial context set up signaling. An example of an initial context signaling is described at 3GPP TS 36.413 V10.5.0 (2012-03), Technical Specification, 3rd Generation Partnership Project, Technical Specification Group Radio Access Network, Evolved Universal Terrestrial Radio Access Network, (E-UTRAN), S1 Application Protocol (S1AP), (Release 10), although other signaling processes may be used as well.

In example embodiments configured with an eNB type base station, the eNB base station 110A may check the user equipment's consent. If positioning activation is requested, the eNB base station 110A may trigger, at 420, a start of the positioning via the SUPL agent 410. For example, the eNB base station 110 may inform at 420 the MME 198 about the requested positioning. The requested positioning at 420 may include an identity (e.g., a temporary ID, such as a Temporary Mobile Subscriber Identity (TMSI)) for the selected user equipment. The request at 420 may be sent in accordance with a Location Report message consistent with 3GPP TS 36.413. The Location Report (as shown below at Table 1) may also include a Request Type (as shown below at Table 2) configured (or extended) to include “start positioning” and “stop positioning,” although a message may be defined to specifically carry this information as well.

Once the MME 198 receives the request 420 and is thus aware of the user equipment identity and the request for on-demand positioning, the initiation of the SUPL session from the SUPL 196 and the user equipment 114 may follow a similar process as described above with respect to signaling based MDT.

TABLE 1
Location Report

| | | | IE type and | Semantics | | Assigned |
|---|---|---|---|---|---|---|
| IE/Group Name | Presence | Range | reference | description | Criticality | Criticality |
| Message Type | M | | 9.2.1.1 | | YES | ignore |
| MME UE S1AP ID | M | | 9.2.3.3 | | YES | reject |
| eNB UE S1AP ID | M | | 9.2.3.4 | | YES | reject |
| E-UTRAN CGI | M | | 9.2.1.38 | | YES | ignore |
| TAI | M | | 9.2.3.16 | | YES | ignore |
| Request Type | M | | 9.2.1.34 | The Request Type | YES | ignore |
| | | | | IE is sent as it | | |
| | | | | has been provided. | | |

TABLE 2
Request Type

| | | | | |
|---|---|---|---|---|
| IE/Group | Pres- | | | Semantics |
| Name | ence | Range | IE Type and Reference | Description |

| | | | |
|---|---|---|---|
| Request Type | | | |
| >Event | M | ENUMERATED(Direct, | |
| | | Change of service cell, | |
| | | Stop Change of service | |
| | | cell, Start SUPL posi- | |
| | | tioning, Stop SUPL | |
| | | positioning) | |
| >Report Area | M | ENUMERATED | |
| | | (ECGI, . . .) | |
| SUPL | O | OMA OMA-TS-ULP- | May include |
| configuration | | V3_0-20110920-C | one or more |
| | | | of the |
| | | | following: |
| | | | positioning |
| | | | method, |
| | | | trigger event, |
| | | | periodicity, |
| | | | quality of |
| | | | positioning, |
| | | | etc. |

The SUPL agent 410 may be located in the RAN node. In UTRAN, the RAN node may comprise the RNC which may know the user equipment identity and hence would be able to provide user equipment information regarding consent and identity to the SUPL agent to establish the SUPL session with the user equipment that has been selected for the MDT measurements. The SUPL agent itself may also communicate with the core network node or an O&M node to obtain required information about the user equipment to be able to initiate the connection to the selected user equipment. In LTE, the eNB is not aware of the UE identity for security reasons. Otherwise, the procedure would be such that when configuring the MDT measurement to the selected user equipment, the eNB may also trigger also the SUPL agent to initiate a SUPL session in order to start appropriate positioning function at the selected user equipment.

The positioning at the user equipment 114A triggered by SUPL agent 420 may be GNSS, terrestrial, and the like as noted above with respect to system 300. When the MDT session ends, the eNB may, as noted above with respect to system 300, inform the MME 198 as well as other nodes regarding the termination of the MDT measurements and thus triggering the de-activation of the SUPL positioning at the user equipment.

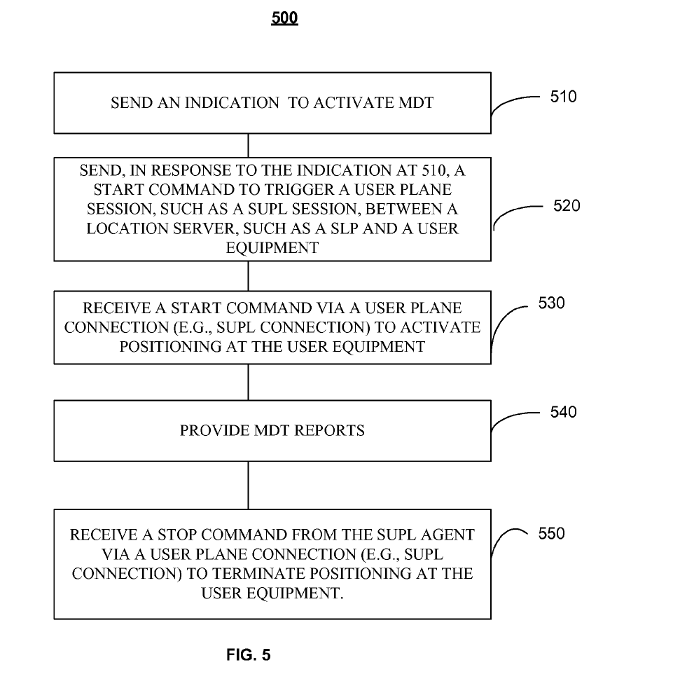

FIG. 5 depicts a process 500 for requested positioning activation for MDT, in accordance with some example embodiments.

At 510, an indication may be sent to activate MDT, in accordance with some example embodiments. For example, an O&M function in the network may send a request, such as a Trace request to initiate collecting MDT information. The indication may be sent to another node, such as MME 198, eNB 110A, and the like. For example, in signaling based MDT, the O&M node 199 may send the Trace request to initiate collecting MDT information to the MME 198, while in area based MDT, the O&M node 199 may send an indication to the eNB to select one or more user equipment for MDT reporting and positioning.

At 520, a SUPL agent (which may be at a network node or connected to a network node) may send, in response to the indication at 510, a start command via a user plane session, such as a SUPL session, between a location server (e.g., a SLP) and a user equipment, in accordance with some example embodiments. For example, MME 198 (which may include or be connected to SUPL agent 210) may send a start command to trigger a SUPL session between SLP 196 and user equipment 114A to activate positioning, such as GNSS, terrestrial, and the like, at the user equipment 114A. This positioning information may be provided to the network in the MDT reports sent via the RRC connection to facilitate the MDT processing function at radio access network and at O&M node 199.

At 530, user equipment 114A may receive a start command via a user plane connection (e.g., SUPL connection) to activate positioning at the user equipment. For example, the user equipment 114A may provide, at 540, MDT reports to the network and these reports may include positioning, such as GNSS location information, triggered by SLP 196 via a user plane connection, such as a SUPL via connection 150. Moreover, SLP 196 may provide assistance information to assist the user equipment to generate the GNSS location information

At 550, the SUPL agent may send a stop command to SLP 196 to terminate the SUPL positioning session between the user equipment 114A and SLP 196. The stop command may be triggered by an end of a MDT session. In any case, the user equipment 114A may receive the stop command from the SLP 196 via a user plane connection (e.g., SUPL connection) to terminate positioning at the user equipment. For example, SUPL agent may terminate the SUPL session when the O&M node 199 indicates to the SUPL agent an end to the MDT (or Trace). In this example, SUPL agent send a stop command to the SLP 196 and user equipment including SUPL function 190A to stop positioning.

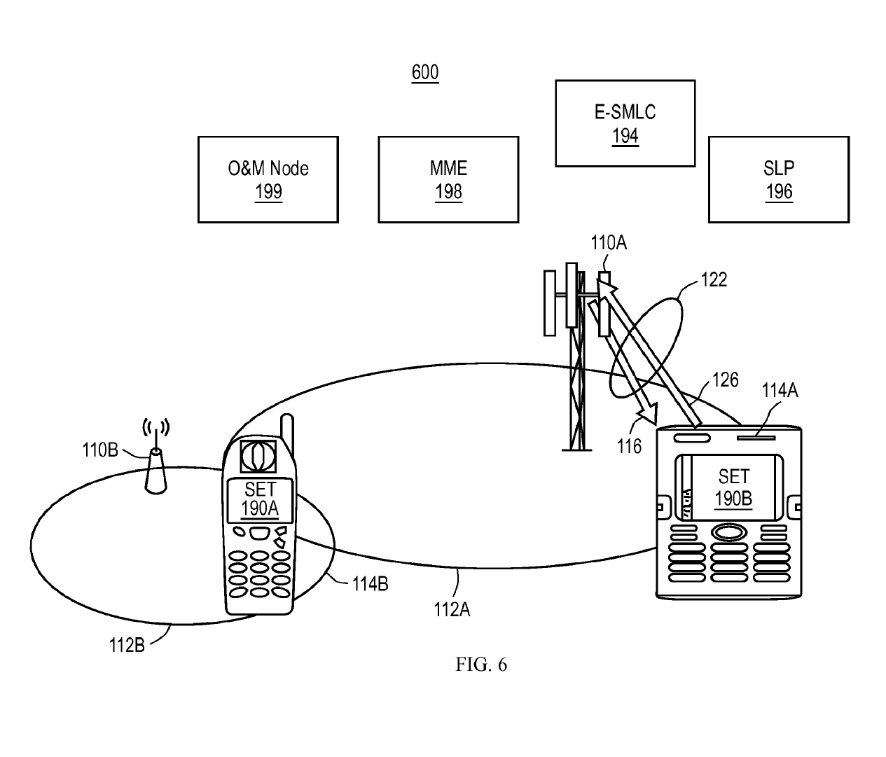

FIG. 6 describes an example wireless communication system 600 including some of the elements described herein. The wireless communication system may include one or more base stations, such as base stations 110A-B supporting corresponding service or coverage areas 112A-B (also referred to as cells). The base stations 110A-B may be capable of communicating with wireless devices, such as user equipment 114A-B, within its coverage areas.

Moreover, the base stations 110A-B may, in some example embodiments, be implemented as an evolved Node B (eNB) type base station consistent with standards, including the Long Term Evolution (LTE) standards, such as 3GPP TS 36.201, Evolved Universal Terrestrial Radio Access (E-UTRA); Long Term Evolution (LTE) physical layer; General description, 3GPP TS 36.211, Evolved Universal Terrestrial Radio Access (E-UTRA); Physical channels and modulation, 3GPP TS 36.212, Evolved Universal Terrestrial Radio Access (E-UTRA); Multiplexing and channel coding, 3GPP TS 36.213, Evolved Universal Terrestrial Radio Access (E-UTRA); Physical layer procedures, 3GPP TS 36.214, Evolved Universal Terrestrial Radio Access (E-UTRA); Physical layer—Measurements, and any subsequent additions or revisions to these and other 3GPP series of standards (collectively referred to as LTE standards).

Although FIG. 1 depicts an example of a configuration for base stations 110A-B, base stations 110A-B may be configured in other ways including, for example, relays, cellular base station transceiver subsystems, gateways, access points, radio frequency (RF) repeaters, frame repeaters, nodes, and include access to other networks as well. For example, base stations 110A-B may have wired and/or wireless backhaul links to other network elements, such as other base stations, a radio network controller, a core network, a serving gateway, an OAM node 199, a mobility management entity 198, an SLP 196, an E-SMLC 194, a serving GPRS (general packet radio service) support node, a network management system, and the like.

In some example embodiments, the user equipment 114A-B may be SUPL enabled to activate positioning at the user equipment. The user equipment 114A-B may be implemented as a mobile device and/or a stationary device. The user equipment 114A-B are often referred to as, for example, mobile stations, mobile units, subscriber stations, wireless terminals, tablets, smart phones, or the like. A user equipment may be implemented as, for example, a wireless handheld device, a wireless plug-in accessory, or the like. In some cases, user equipment may include a processor, a computer-readable storage medium (e.g., memory, storage, and the like), a radio access mechanism, and/or a user interface.

In some example embodiments, the wireless communication system 100 may include access links, such as links 122. The access links 122 include a downlink 116 for transmitting to the user equipment 114A and an uplink 126 for transmitting from user equipment 114A to the base station 110A. The downlink 116 may comprise a modulated radio frequency carrying information, such as RRC messages, location information, and the like, to the user equipment 114A, and the uplink 126 may comprise a modulated radio frequency carrying information, such as RRC messages, assistance information, location information, MDT reports, and the like, from the user equipment 114A to base station 110A. User equipment 114B may include links which are similar to (or different from) links 122. The downlink 116 and uplink 126 may, in some example embodiments, each represent a radio frequency (RF) signal. The RF signal may, as noted above, include data, such as voice, video, images, Internet Protocol (IP) packets, control information, and any other type of information and/or messages. For example, when LTE is used, the RF signal may use OFDMA. OFDMA is a multi-user version of orthogonal frequency division multiplexing (OFDM). In OFDMA, multiple access is achieved by assigning, to individual users, groups of subcarriers (also referred to as subchannels or tones). The subcarriers are modulated using BPSK (binary phase shift keying), QPSK (quadrature phase shift keying), or QAM (quadrature amplitude modulation), and carry symbols (also referred to as OFDMA symbols) including data coded using a forward error-correction code. The subject matter described herein is not limited to application to OFDMA systems, LTE, LTE-Advanced, or to the noted standards and specifications.

Although FIG. 1 depicts two base stations 110A-B, two cells 112A-B, and two user equipment 114A-B, a single O&M node 199, and a single MME 198, a single E-SMLC 194, and a single SLP 196, wireless communication system 100 may include other quantities of these devices as well.

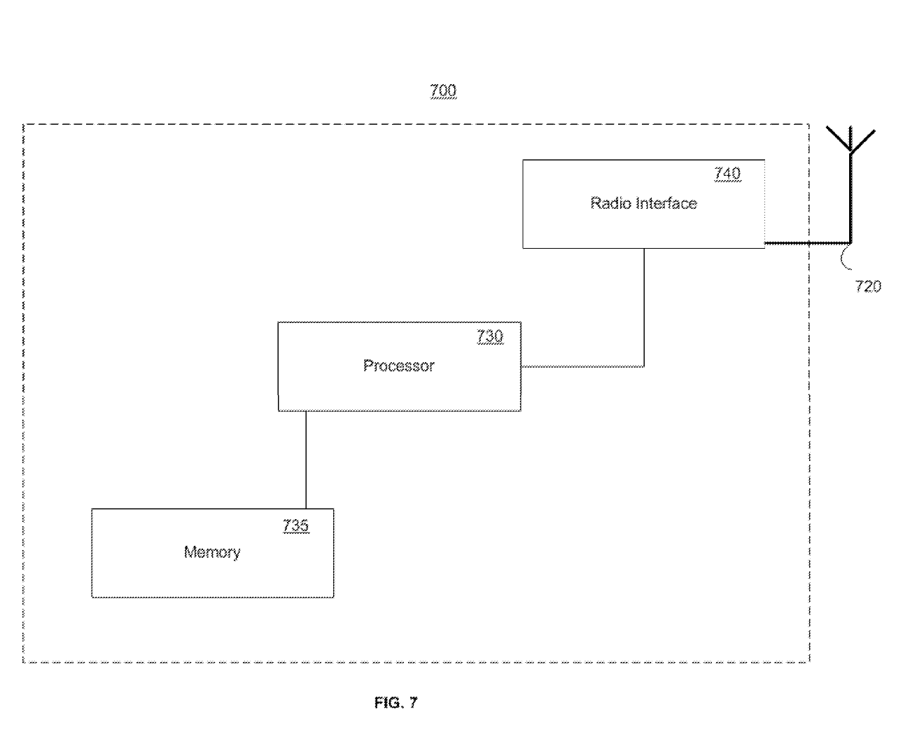

FIG. 7 depicts an example implementation of a base station 700, which may be implemented at base station 110A-B. The base station may include one or more antennas 720 configured to transmit via a downlink and configured to receive uplinks via the antenna(s) 720. The base station may further include a radio interface 740 coupled to the antenna 720, a processor 730 for controlling the base station 700 and for accessing and executing program code stored in memory 735. The radio interface 740 may further include other components, such as filters, converters (e.g., digital-to-analog converters and the like), mappers, a Fast Fourier Transform (FFT) module, and the like, to generate symbols for a transmission via one or more downlinks and to receive symbols (e.g., via an uplink). In some implementations, the base station may also be compatible with IEEE 802.16, LTE, LTE-Advanced, and the like, and the RF signals of downlinks and uplinks are configured as an OFDMA signal. The processor 730 may access code in memory, which causes base station 700 to provide one or more of the operations described herein with respect to a base station. The network nodes described herein, such as the O&M Node, the MME, the E-SMLC, the SUPL agent, the SLP, and the like may each comprise at least one processor and at least one memory including code, which when executed by the at least one processor provides one or more aspects of the device.

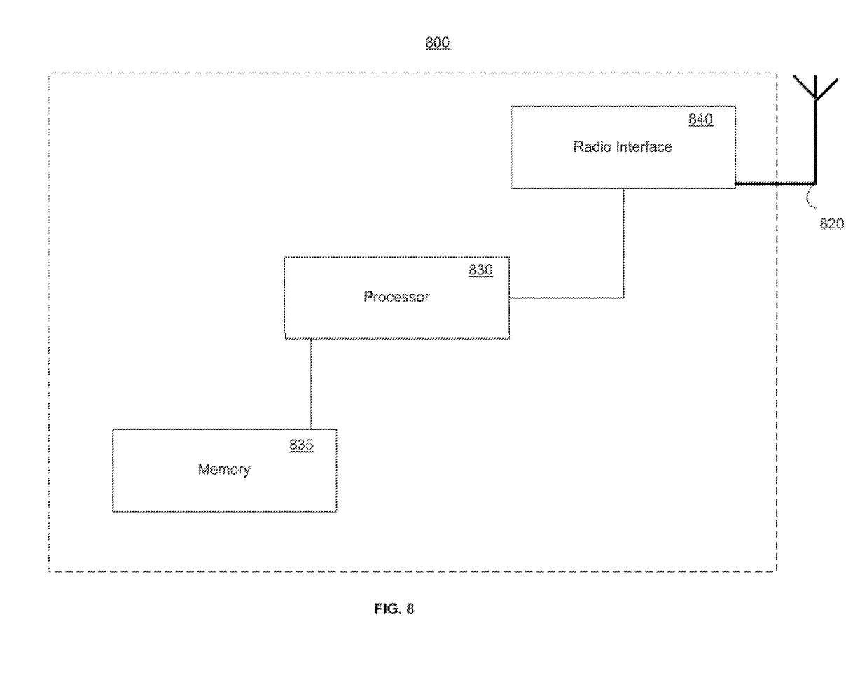

FIG. 8 depicts a block diagram of a radio, such as a user equipment 800. The user equipment 800 may be SUPL enabled. Moreover, the user equipment 800 may include an antenna 820 for receiving a downlink and transmitting via an uplink. The user equipment 800 may also include a radio interface 840, which may include other components, such as filters, converters (e.g., digital-to-analog converters and the like), symbol demappers, signal shaping components, an Inverse Fast Fourier Transform (IFFT) module, and the like, to process symbols, such as OFDMA symbols, carried by a downlink or an uplink. In some implementations, the user equipment 800 may also be compatible with WiFi, Bluetooth, GERAN, UTRAN, E-UTRAN, and/or other standards and specifications as well. The user equipment 800 may further include at least one processor, such as processor 830, for controlling user equipment 800 and for accessing and executing program code stored in memory 835. The processor 830 may access code in memory, which causes user equipment 800 to provide one or more of the operations described herein with respect to the user equipment.

The subject matter described herein may be embodied in systems, apparatus, methods, and/or articles depending on the desired configuration. For example, the base stations and user equipment (or one or more components therein) and/or the processes described herein can be implemented using one or more of the following: a processor executing program code, an application-specific integrated circuit (ASIC), a digital signal processor (DSP), an embedded processor, a field programmable gate array (FPGA), and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. These computer programs (also known as programs, software, software applications, applications, components, program code, or code) include machine instructions for a programmable processor, and may be implemented in a high-level procedural and/or object-oriented programming language, and/or in assembly/machine language. As used herein, the term “machine-readable medium” refers to any computer program product, computer-readable medium, computer-readable storage medium, apparatus and/or device (e.g., magnetic discs, optical disks, memory, Programmable Logic Devices (PLDs)) used to provide machine instructions and/or data to a programmable processor, including a machine-readable medium that receives machine instructions. Similarly, systems are also described herein that may include a processor and a memory coupled to the processor. The memory may include one or more programs that cause the processor to perform one or more of the operations described herein.

Although a few variations have been described in detail above, other modifications or additions are possible. In particular, further features and/or variations may e provided in addition to those set forth herein. Moreover, the implementations described above may be directed to various combinations and subcombinations of the disclosed features and/or combinations and subcombinations of several further features disclosed above. In addition, the logic flow depicted in the accompanying figures and/or described herein does not require the particular order shown, or sequential order, to achieve desirable results. Other embodiments may be within the scope of the following claims.

1-22. (canceled)

23. A method comprising:
receiving, at a user plane agent, an indication to activate positioning at a user equipment to provide positioning information for a minimization of drive testing processing;
establishing, based on the received indication, a user plane connection, between a location server and the user equipment; and
sending, by the user plane agent, a start command via the user plane connection to activate the positioning at the user equipment.

24. The method of claim 23, wherein the user plane connection comprises a secure tunnel configured in accordance with secure user plane location, wherein the user equipment comprises a secure user plane location enabled terminal, and wherein the location server comprises a secure user plane location platform.

25. The method of claim 23, wherein the receiving further comprises:
receiving, during a trace function used for the minimization of drive testing processing, the indication at a network node comprising, or connected to, the user plane agent.

26. The method of claim 25, wherein the network node comprises at least one of a mobility management entity, a radio access node, or an operations and maintenance node.

27. The method of claim 23, further comprising:
sending, via the user plane connection to the user equipment, a positioning method for use at the user equipment.

28. The method of claim 23, further comprising:
sending, via the user plane connection to the user equipment, an assistance information to assist in a global navigation satellite system positioning at the user equipment.

29. An apparatus comprising:
at least one processor; and
at least one memory including computer program code for one or more programs, the at least one processor, the at least one memory, and the computer program code configured to cause the apparatus to at least:
receive, at a user plane agent, an indication to activate positioning at a user equipment to provide positioning information for a minimization of drive testing processing;
establish, based on the received indication, a user plane connection, between a location server and the user equipment; and
send, by the user plane agent, a start command via the user plane connection to activate the positioning at the user equipment.

30. The apparatus of claim 29, wherein the user plane connection comprises a secure tunnel configured in accordance with secure user plane location, wherein the user equipment comprises a secure user plane location enabled terminal, and wherein the location server comprises a secure user plane location platform.

31. The apparatus of claim 29, wherein the receive further comprises:
receive, during a trace function used for the minimization of drive testing processing, the indication at a network node comprising, or connected to, the user plane agent.

32. The apparatus of claim 31, wherein the network node comprises at least one of a mobility management entity, a radio access node, or an operations and maintenance node.

33. The apparatus of claim 29, further comprising:
send, via the user plane connection to the user equipment, a positioning method for use at the user equipment.

34. The apparatus of claim 29, further comprising:
send, via the user plane connection to the user equipment, an assistance information to assist in a global navigation satellite system positioning at the user equipment.

35. An apparatus comprising:
at least one processor; and
at least one memory including computer program code for one or more programs, the at least one processor, the at least one memory, and the computer program code configured to cause the apparatus to at least:
activate, at the user equipment, positioning based on a start command received from a user plane agent via a user plane connection, wherein the start command activates positioning at the user equipment in order to provide positioning information for a minimization of drive testing processing; and
send, by the user equipment, at least one of a minimization of drive testing report and the positioning information.

36. The apparatus of claim 35, wherein the user plane connection comprises a secure tunnel configured in accordance with secure user plane location, and wherein the user equipment comprises a secure user plane location enabled terminal.

37. The apparatus of claim 35 wherein the start command is further received during a trace function used for the minimization of drive testing processing from a network node comprising, or connected to, the user plane agent.

38. The apparatus of claim 37, wherein the network node further comprises at least one of a mobility management entity, a radio access node, or an operations and maintenance node.

39. The apparatus of claim 35, wherein the activate further comprises:
activate a global navigation satellite system positioning at the user equipment.
